(19) United States
(12) Patent Application Publication
(10) Pub. No.: US 2009/0314610 A1
(43) Pub. Date: Dec. 24, 2009

(54) Transfer device for a transport system

(76) Inventor: Rudolf Hansl, Linz (AT)

Correspondence Address: COLLARD & ROE, P.C., 1077 NORTHERN BOULEVARD, ROSLYN, NY, 11576, US

(21) Appl. No.: 11/919,691

(22) PCT Filed: May 8, 2006
(86) PCT No.: PCT/AT2006/000187

§ 371 Date: Jul. 2, 2009

(30) Foreign Application Priority Data
May 13, 2005 (AT) A 826/2005

(51) Int. Cl. B65G 47/52

(52) U.S. Cl. 198/468.6

(57) ABSTRACT

The invention relates to a transfer system (12) for a transport system (1) having at least one conveyor track (3, 4, 5) for objects to be conveyed (2), with a base frame (15), with a transfer device (16) comprising a lifting frame (17), a drive mechanism (18) retained on it as well as at least one conveyor means (19) and at least one lifting mechanism (20). The lifting mechanism (20) comprises a lifting rocker (22), which is mounted so as to be reversibly displaceable on the base frame (15) relative to an axis (23) from a non-operating position into a retaining position. The lifting rocker (22) has a rocker track (24), which is disposed at a different distance (25) from it in the direction perpendicular to the axis (23). A drive element (26) of the drive mechanism (18) is drivingly connected to the rocker track (24) of the lifting rocker (22) from its non-operating position until it reaches the retaining position. On reaching the retaining position, the drive element (26) is disconnected from the drive connection to the rocker track (24) or the drive connection between the drive element (26) and the drive mechanism (18) is interrupted.

The invention relates to a transfer system for a transport system comprising at least one conveyor track, in particular for gating in and/or gating out objects to be conveyed, with a base frame, with a transfer device comprising a lifting frame, a drive mechanism retained on it and at least one conveyor means constituting a transfer plane, and at least one lifting mechanism by means of which the lifting frame and hence the transfer plane formed by the conveyor means can be reversibly displaced from a stand-by position underneath a conveyor plane of the transport system into an operating position lying above the conveyor plane, and the one drive mechanism is drivingly connected to both the conveyor means and the lifting mechanism.

Various designs of gating-in and gating-out devices are already known from patent specifications DE 41 24 763 A1, DE 195 00 148 C1 and DE 198 00 549 A1, each of which have separate drive mechanisms for driving the conveyor means on the one hand and for running the lifting function on the other hand, in order to lift the outward transfer traction means above the conveying level, from the conveying level at which it is disposed in the non-operating position. Pneumatic or electromechanical drive units are primarily used as a means of producing the lifting movement. Such inward and/or outward transfer devices have proved very expensive, both as regards their production and in terms of their operation.

Another deflector system for piece goods is known from patent specification DE 31 25 885 C2, whereby the piece goods are fed from a conveyor track to a branch track by means of an outward deflector facing the branch track driven by a motor, the endless discharge belt of which is fed around pulley blocks, guided and supported on a lifting part, and can be lifted with it above the conveyor plane of the conveyor track when the motor is running. This being the case, the discharge belt is connected to a driving wheel and via a pulley wheel for the lifting part to a driving part for eddy current brakes, the output part of which operates the lifting part of the discharge system via a lifting mechanism. The eddy current brake causes the lifting part to be lifted during the running time of the discharge belt driven by the single motor and holds the lifting frame in its upper position until the drive motor is switched off again. The eddy current brake of the lifting mechanism represents additional components which have to be maintained and which have not always proved adequate for the job in all applications in terms of their operation.

Another transport system, in particular for transferring out and/or sorting goods, is known from DE 297 00 863 U1. In this instance, in order to run a defined sorting operation for goods transported along a conveyor run, the conveyor run is formed by several conveyor units, each disposed at a distance apart from one another. The transport system comprises at least one conveyor element of a conveyor unit which can be disposed between two consecutive conveyor units and which can be reversibly displaced at least more or less vertically from a non-operating position underneath the conveyor units into an operating position lying above the conveyor units. The lifting unit is provided in the form of at least one eccentric unit. In order to drive the conveyor element and the eccentric unit, a common drive is provided which simultaneously drives the lifting unit and the conveyor element. Due to the fixed drive connection, the upward and then downward discharge and lifting movement is effected in one continuous cycle once the drive motor is started, and during this time interval the conveyor element is also driven as well, and a conveying movement can only be effected by the conveying element during this limited period. Another disadvantage of this solution resides in the relatively limited range of applications for which this inward and outward transfer system can be used because it is designed for a specific load size only and when there is a change in the size of the conveyed items, the conveyor dimensions have to be adjusted to the new load size.

The underlying objective of the invention is to propose a transfer system which is able to operate with only a single drive mechanism and is able to fulfill the intended function with few drive parts whilst permitting a high degree of flexibility in terms of the conveying and lifting paths of the transfer device.

This objective is achieved by the invention due to the fact that the lifting mechanism has a lifting rocker, which is mounted on the base frame so that it can be reversibly displaced relative to an axis from a non-operating position into a retaining position, and when the lifting rocker is in the non-operating position, the lifting frame together with the conveyor means is in the stand-by position and when the lifting rocker is in the retaining position, the lifting frame together with the conveyor means is in the operating position, and the lifting rocker has at least one rocker track which, in the direction perpendicular to the axis, is disposed at a different distance from it, and a drive element of the drive mechanism is in a driving connection with the rocker track of the lifting rocker starting from its non-operating position until reaching the retaining position, and on reaching the retaining position, the drive element is disconnected from the drive connection to the rocker track, or the drive element of the drive mechanism is always in a driving connection with the rocker track of the lifting rocker and on reaching the retaining position, the driving connection between the drive element and drive mechanism is interrupted.

The surprising advantage obtained as a result of the features defined in this claim resides in the fact that whilst the lifting movement is being effected, the drive element is in a driving connection with the co-operating rocker track and it is not until the lifting frame reaches the pre-defined position that this drive connection is mechanically interrupted. This makes it possible to operate with only one drive mechanism as a means of moving the conveyor means and the lifting mechanism, and in the retaining position, the conveyor means can continue to be driven unhindered. The mechanical uncoupling of the drive connection obviates the need for additional sensors and control systems, which also results in a cost saving and additionally enhances operating safety. Also as a result, variable cycle times can be obtained for the inward and/or outward transfer operation or transfer operation irrespective of the lifting movement.

Another embodiment defined in claim 2 is of advantage because it makes positioning of the drive element with respect to the axis of the lifting rocker easier and therefore offers an easy way of fixing the end positions of the lifting rocker, as well as the non-operating position and the retaining position.

Other embodiments defined in claims 3 to 6 are of advantage because, depending on the intrinsic weight of the lifting frame or lifting mechanism, the lifting rocker is able to center itself automatically in its end positions, thereby enabling additional monitoring systems to be dispensed with. As a result, it is also possible for the lifting rocker to return to its non-operating position automatically.

The embodiment defined in claim 7 enables the lifting height of the transfer system to be pre-defined and the speed of the lifting movement can be simultaneously influenced depending on the changing distance of the rocker track from the axis. Accordingly, the rocker track may be provided in the form of a control cam, by means of which it is possible to achieve a rapid lifting movement to the point at which the object to be conveyed is detected, after which the object to be conveyed can be lifted with a different lifting movement, and the conveyor means of the transfer system can always be moved onwards at the same conveying speed.

In other variants of embodiments defined in claims 8 to 10, a uniform lifting speed of the transfer system is obtained, and in addition, the lifting rocker is able automatically to center itself whilst still in the non-operating position without an additional automatic shut-off system and sensors. Furthermore, it is possible to select any conveying direction of the conveyor means, and the lifting rocker is always connected to the drive element and always effects the same lifting movements for the same lifting height.

The embodiments defined in claim 11 or 12 are also of advantage because the lifting rocker can be retained free of transverse forces in at least one of the two end positions without additional retaining elements, thereby resulting in extra savings on weight and costs for additional system parts.

The embodiment defined in claim 13 or 14 is of advantage because the lifting rocker can be retained in a stable position in its end position without additional retaining means and is not returned from the retaining position to the non-operating position until force is applied by the drive element due to a rotating movement in the opposite direction. By selecting the angle with respect to the horizontally extending plane, the retaining force and hence the return force which needs to be applied in order to move from the retaining position into the non-operating position of the lifting rocker can be fixed.

As a result of another embodiment defined in claim 15 or 16, a positive drive connection is obtained, by means of which a reliable relative position of the transfer device with respect to the base frame is achieved.

The embodiments defined in claims 17 to 20 prevent the system weight or object weight from being transferred between the mutually meshing tooth connections, thereby ensuring perfect meshing of the drive connection and hence a wear-free drive connection. This enables supporting forces to be transferred between the drive element and the lifting rocker without affecting parts involved in the mutually meshing drive connection.

Also of advantage are the embodiments defined in claims 21 to 25 because the two end positions at two ends of the lifting rocker are fixed by means of mechanical stops, so that on reaching the retaining position, there is no need for additional shut-off sensors, thereby saving on costs and ensuring a higher operating safety.

Based on one embodiment as defined in claim 26 or 27, a reliable separation of the drive connection between the drive element and rocker track of the lifting rocker is obtained, and once this position is reached, the conveyor means can continue to be driven unhindered so that the item to be conveyed can be conveyed onwards unimpeded.

The embodiments defined in claims 28 to 31 have proved to be of advantage because they result in a drive unit which can be easily accommodated in the smallest space and which can be easily moved into an active connection with the common drive mechanism. It is also possible to exchange individual components easily, thereby making it easy and inexpensive to adapt to changing operating conditions.

As a result of another advantageous embodiment based on claim 32, another option of establishing the drive connection between the drive element and lifting rocker is proposed, whereby the system weight is also used as a means of applying the requisite friction force for a reliable drive connection.

Also of advantage are embodiments defined in claims 33 to 41 because when the lifting rocker reaches the top dead center point, in other words its retaining position, the lifting movement is restricted by means of co-operating mechanical stops and the transfer device assumes an unequivocal position without the need for additional shut-off sensors. Due to the co-operation of the mechanical stops and the interruption of the drive connection due to a transfer of torque, the conveyor means can continue to operate unhindered in order to transfer the object to be conveyed. Furthermore, the lifting rocker is able to effect an unobstructed pivoting movement relative to the support frame or drive element. By selecting the mounting of the stop wheel accordingly, wear between the stop elements and the stop in the region of the drive element can be significantly reduced, thereby resulting in a significantly longer service life.

Based on an embodiment as defined in claim 42 or 43, a reliable separation of the drive connection between the drive element and rocker track of the lifting rocker is achieved, and when this position is reached, the conveyor means can continue to be driven unhindered, thereby enabling the object to be conveyed onwards without restriction.

An embodiment such as that defined in claim 44 has proved to be of advantage because it results in a simple drive unit that can be accommodated in the smallest space and which can be easily moved into an active connection with the common drive mechanism. It is also possible to replace individual components easily, thereby enabling changes to be made rapidly to changing operating conditions without problems and inexpensively.

As defined in claim 45 or 46, even better force transmission is obtained from the drive element to the rocker track, which can also be further enhanced by means of the pressing element. At the same time, however, the lifting rocker is more efficiently guided relative to the drive element.

The embodiments defined in claims 47 to 51 also result in a mechanical stop restriction and positioning of the lifting rocker relative to the base frame, and when the lifting rocker reaches the retaining position, there is no need for shut-off sensors and a virtually wear-free and unobstructed onward movement or rotating movement of the drive element can be effected without a drive connection between it and the lifting rocker. On changing the direction of rotation of the drive element, the lifting rocker is returned from the retaining position into its non-operating position and a new gating in or gating out operation can then proceed.

Finally, however, another embodiment as defined in claim 52 is possible because the position of the transfer device with respect to the base frame is more or less vertical, thereby more or less or totally preventing a horizontal shift of the conveyor means relative to the base frame.

The invention will be described in more detail below with reference to examples of embodiments illustrated in the appended drawings.

Of these:

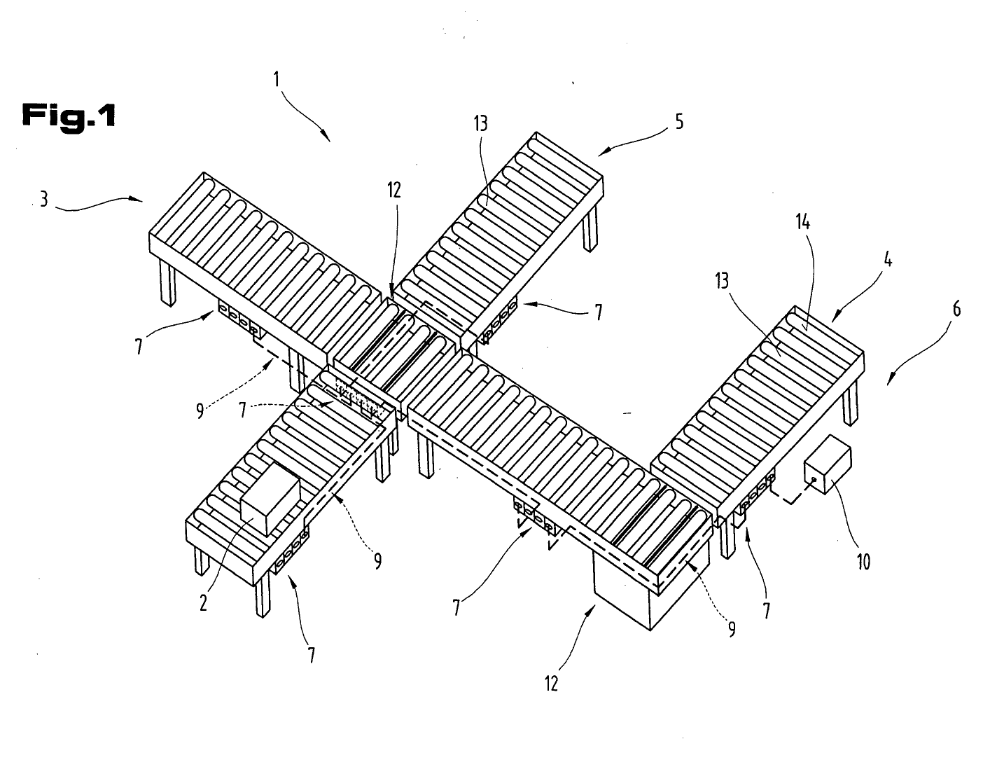

FIG. 1 is a schematic diagram illustrating an example of a transport system with several conveyor tracks and transfer systems;

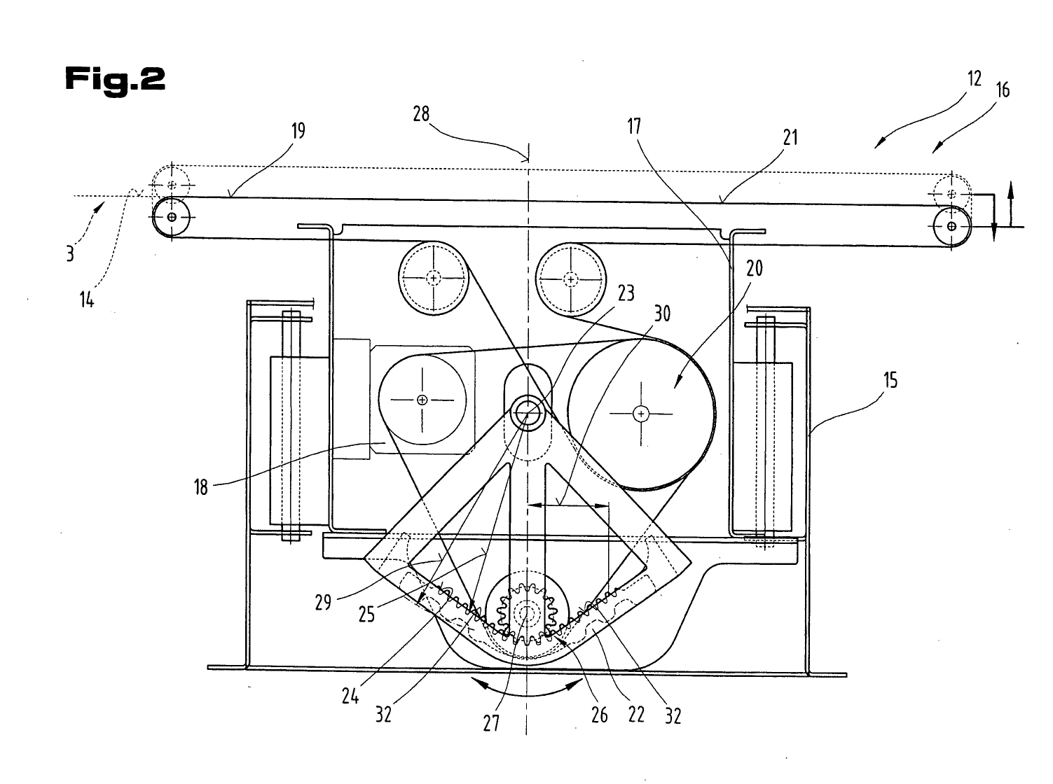

FIG. 2 is a schematic, highly simplified diagram illustrating a front view of one possible embodiment of the transfer system proposed by the invention in its stand-by position;

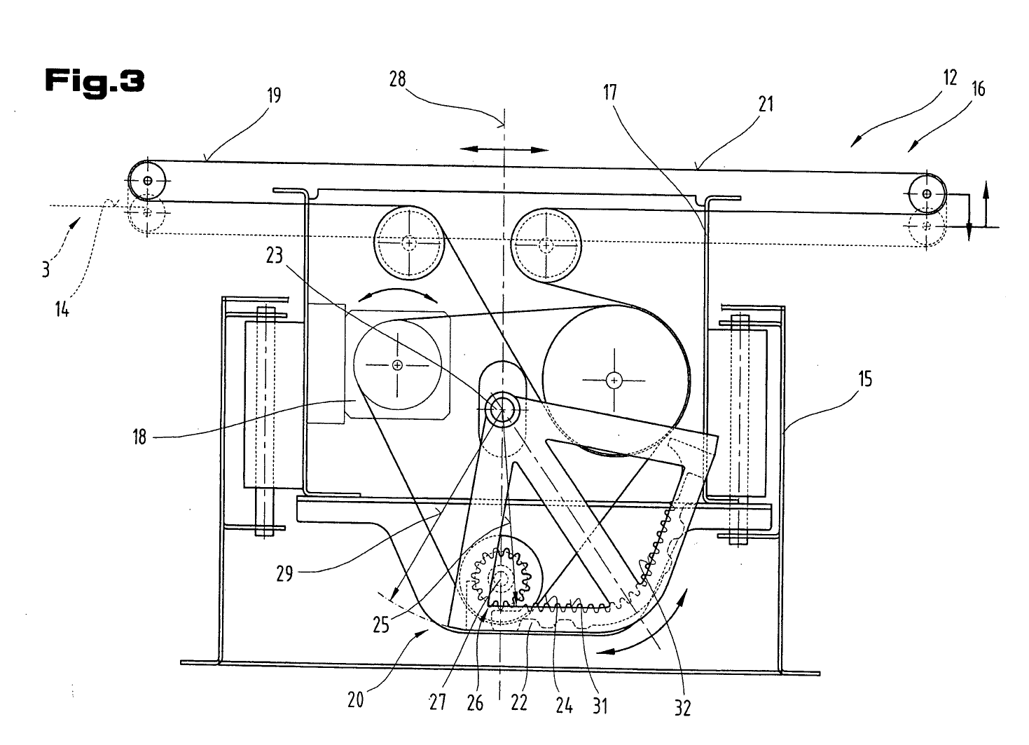

FIG. 3 shows the transfer system illustrated in FIG. 2, but in the operating position;

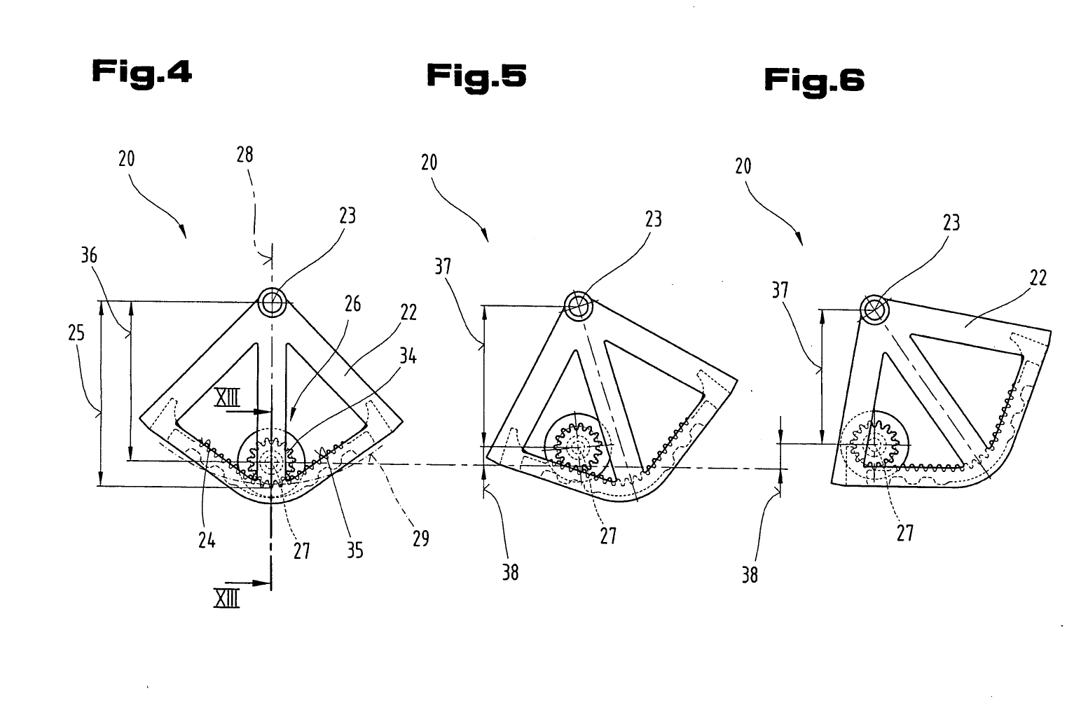

FIG. 4 is a schematic, highly simplified diagram showing a front view of the lifting rocker of the transfer system in its non-operating position as illustrated in FIGS. 1 and 2;

FIG. 5 shows the lifting rocker illustrated in FIG. 4 in an intermediate position between the non-operating position and retaining position;

FIG. 6 shows the lifting rocker illustrated in FIGS. 4 and 5 in its retaining position;

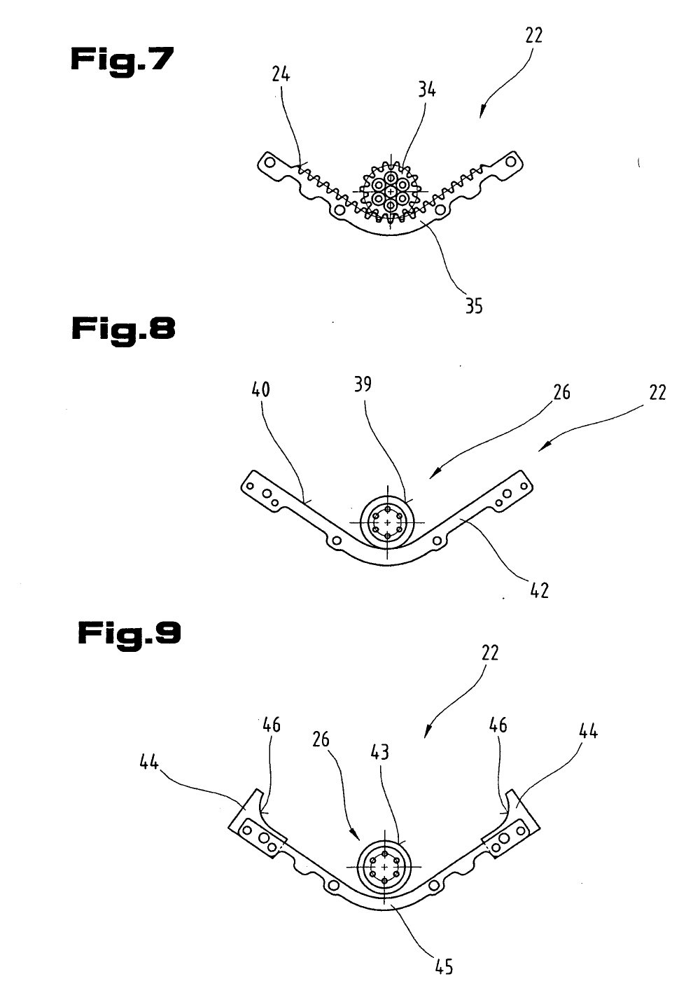

FIG. 7 shows a part-region of the lifting rocker illustrated in FIGS. 4 to 6 in the non-operating position;

FIG. 8 shows another part-region of the lifting rocker illustrated in FIGS. 4 to 6 in the non-operating position;

FIG. 9 shows another part-region of the lifting rocker illustrated in FIGS. 4 to 6 in the non-operating position;

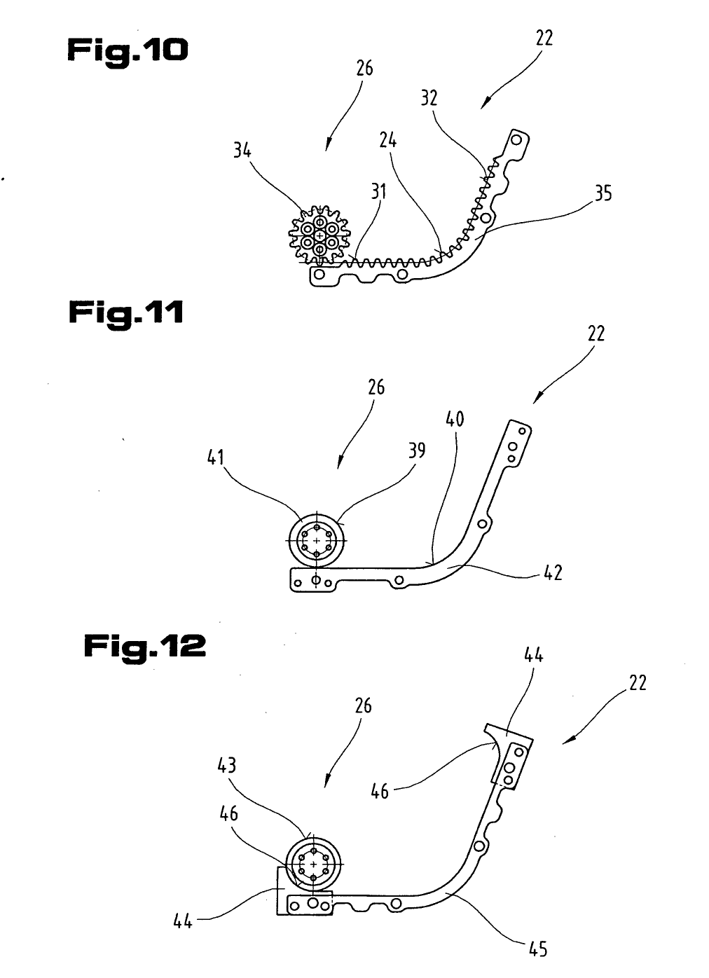

FIG. 10 shows the part-region illustrated in FIG. 7, but in the retaining position;

FIG. 11 shows the part-region illustrated in FIG. 8, but in the retaining position;

FIG. 12 shows the part-region illustrated in FIG. 9, but in the retaining position;

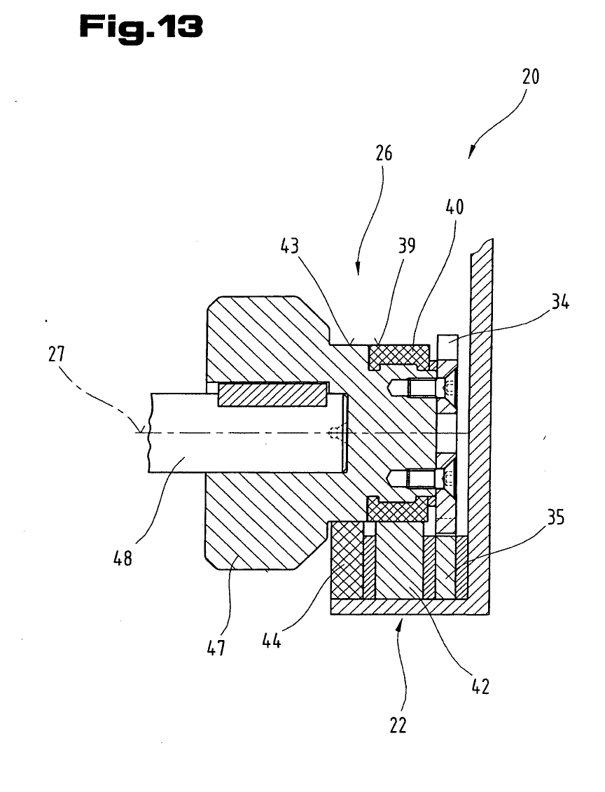

FIG. 13 is a side view of a part-region of the lifting mechanism in section along line XIII-XIII indicated in FIG. 4;

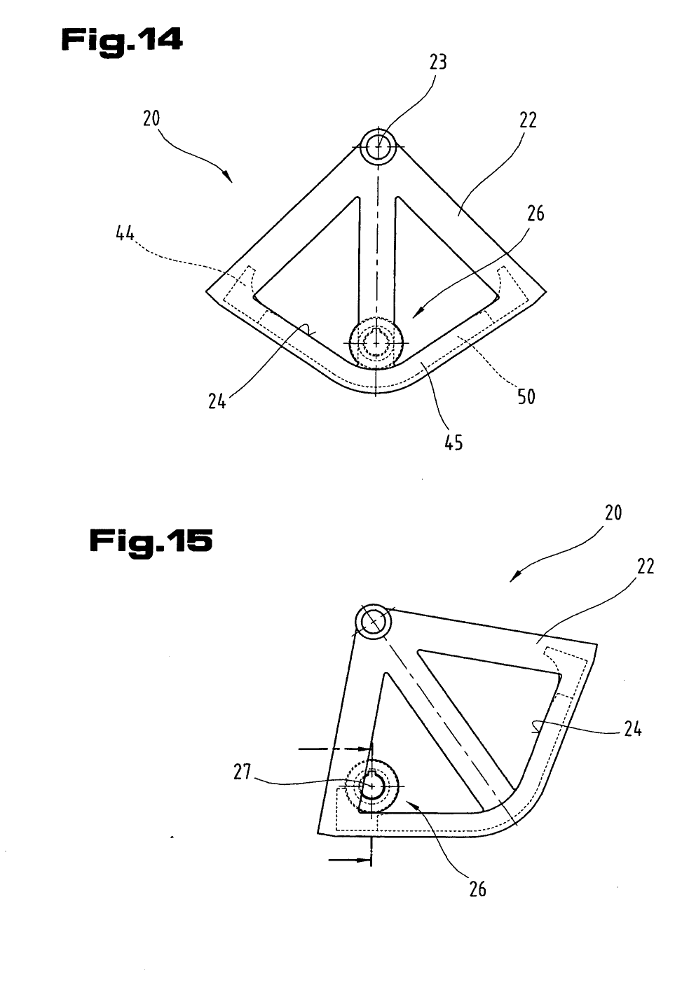

FIG. 14 is a schematic, simplified diagram showing a front view of another embodiment of the lifting rocker of the transfer system in its non-operating position;

FIG. 15 shows the lifting rocker illustrated in FIG. 14 in its retaining position;

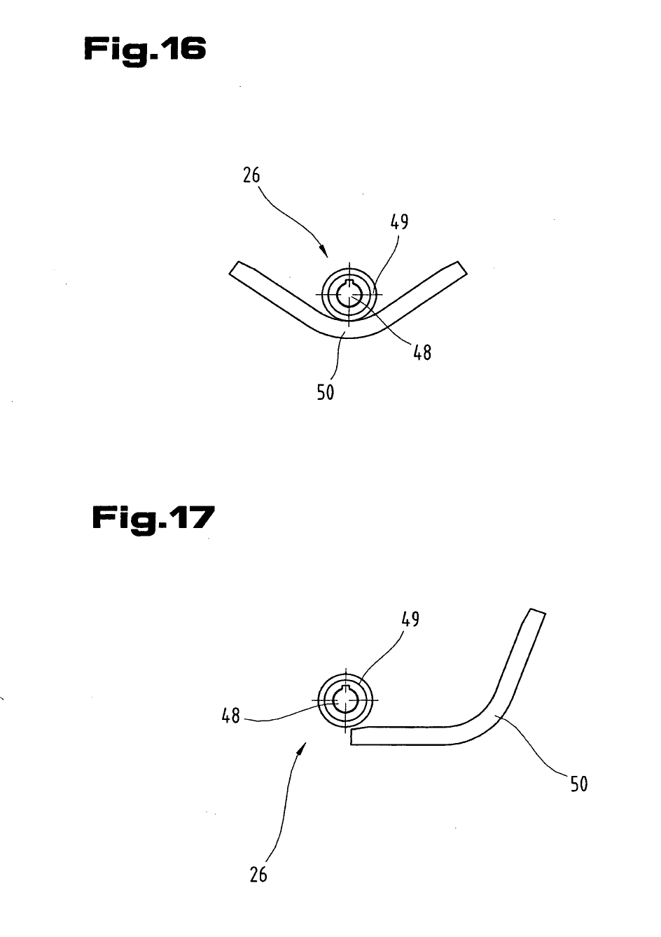

FIG. 16 shows a part-region of the lifting rocker illustrated in FIGS. 14 and 15 in the non-operating position;

FIG. 17 shows a part-region of the lifting rocker illustrated in FIGS. 14 and 15 in the retaining position;

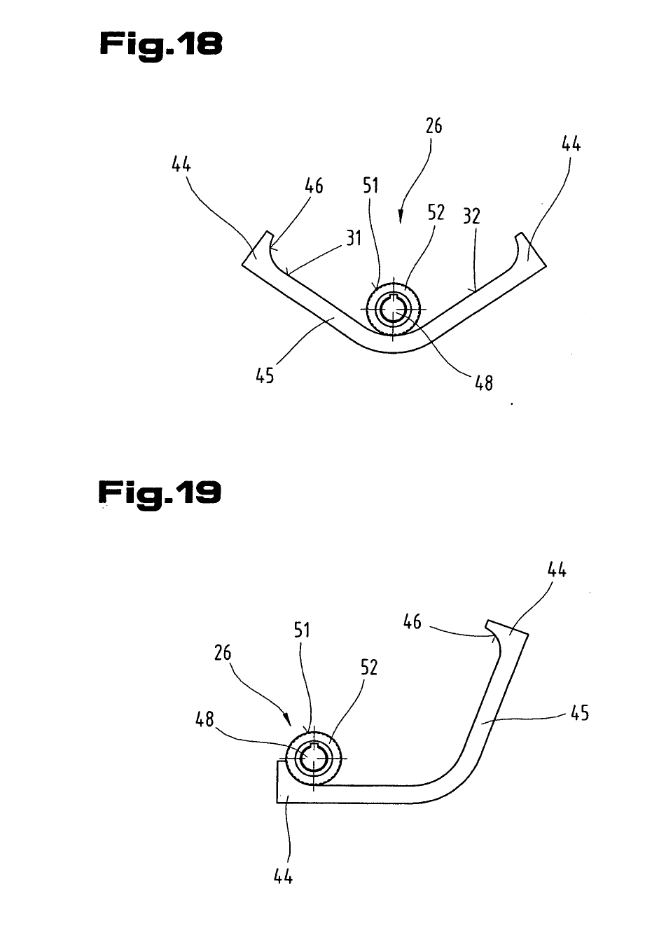

FIG. 18 shows a different part-region of the lifting rocker illustrated in FIGS. 14 and 15 in the non-operating position;

FIG. 19 a different part-region of the lifting rocker illustrated in FIGS. 14 and 15 in the retaining position;

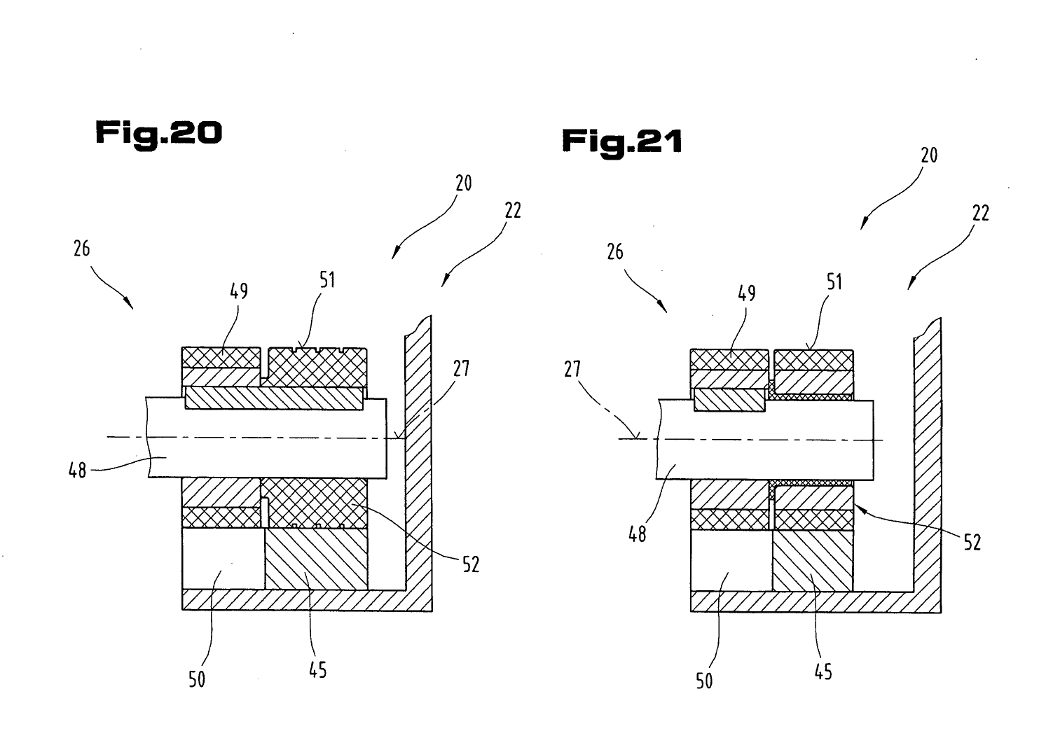

FIG. 20 is a side view of a part-region of the lifting mechanism, in section along line XX-XX indicated in FIG. 15;

FIG. 21 is a side view in section showing another possible embodiment of the lifting mechanism;

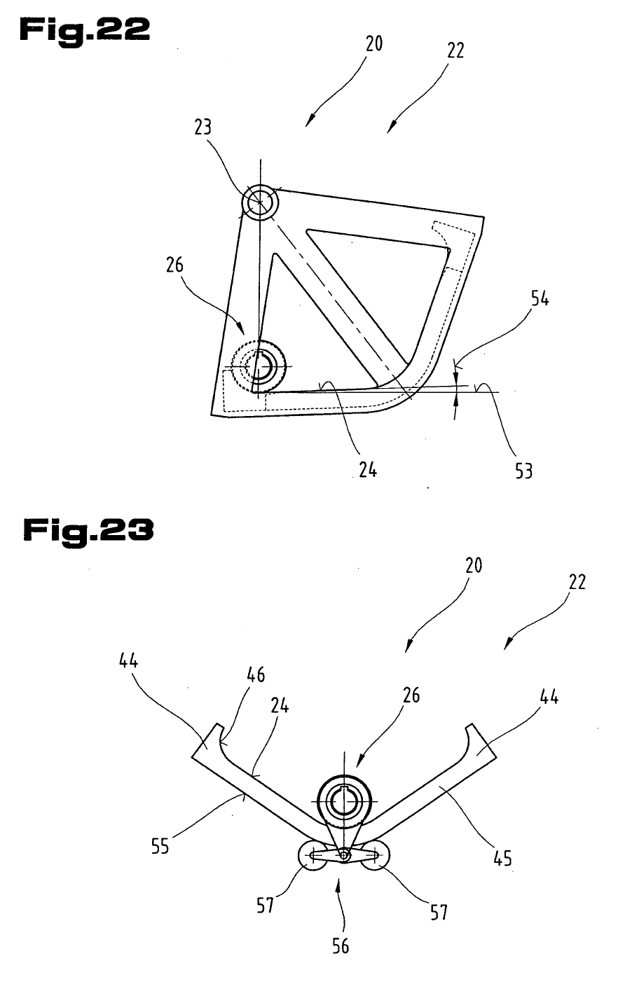

FIG. 22 is a schematically simplified diagram showing a front view of another possible embodiment of the lifting rocker of the transfer system in its non-operating position;

FIG. 23 is a schematically simplified diagram showing a front view of another embodiment of a part-region of the lifting rocker of the transfer system in its non-operating position;

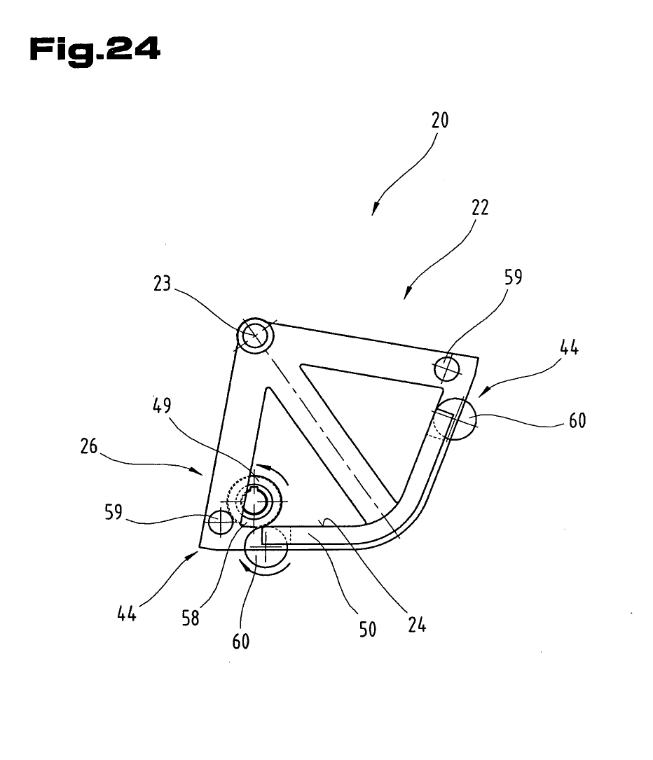

FIG. 24 is a schematically simplified diagram showing a front view of another possible embodiment of the lifting rocker of the transfer system in its non-operating position;

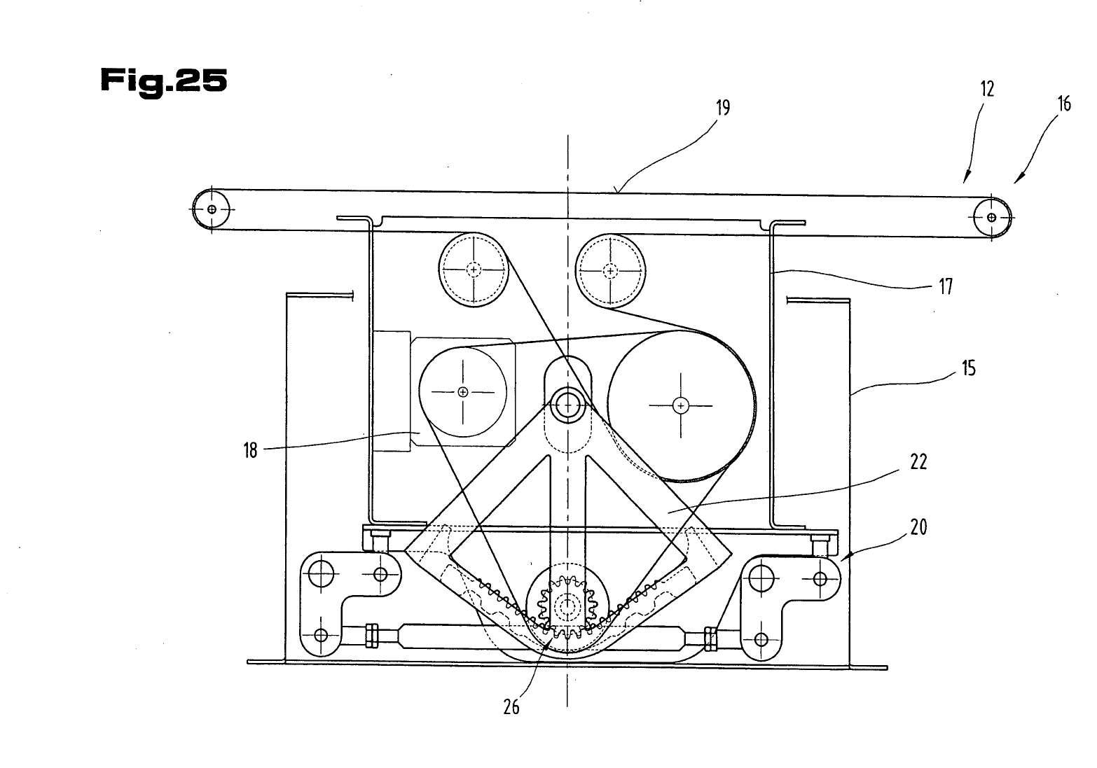

FIG. 25 is a schematic, highly simplified diagram showing a front view of another possible embodiment of the transfer system proposed by the invention in its stand-by position.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 illustrates an example of one of many possible embodiments of a transport system 1 based on a modular design for transporting individual objects to be conveyed 2. The individual objects to be conveyed 2 or piece goods might be parcels, containers, workpiece holders, workpieces or boards, palettes, etc., which can be moved to respective desired or necessary positions within the erected transport system 1 by means of modular, assembled conveyor tracks 3, 4, 5.

The individual procedures in the transport system 1 illustrated as an example take place on an at least partially automated basis, for which purpose an electric control system 6 is provided, comprising several electrical and electronic control devices 7. In particular, each of the conveyor tracks 3, 4, 5, or at least the modular conveyor tracks 3, 4, 5, which are each of a separate construction, has a separate control device 7 for at least automating control of the operating sequences of the respective conveyor tracks 3, 4, 5. The control devices 7 are connected via a data network 9 of a type known from the prior art so that they can at least communicate with one another. Due to the control devices 7 connected to the data network 9, an orderly exchange of data or information or a rapid data transmission can take place between the control devices 7 of the different conveyor tracks 3, 4, 5 without the need for a plurality of information or data cables. The control devices 7 coupled with one another for control purposes constitute a basis for a planned control sequence within the assembled transport system 1. In particular, the functional interaction between the local control devices 7 containing intelligence for control purposes and the individual conveyor tracks 3, 4, 5 ensures automated, planned operation of the transport system 1.

The overall control system 6 for the transport system 1 may also incorporate a control computer or a so-called material flow computer 10 of a higher order than the control devices 7 in control terms, which is connected via the data network 9 to the individual control devices 7. The material flow computer 10 may be any memory-programmable controller or an industrial personal computer or some other computer unit which is able to process control programs. The individual control devices 7 are connected to one another consecutively via the data bus 8 and are coupled with the material flow computer 10. In terms of control technology, the control architecture between the individual control devices 7 and the material flow computer 10 may therefore comprise de-centralized, intelligent and at least partially autonomous control devices 7.

Disposed in the region of mutually crossing or branching conveyor tracks 3, 4, 5 are schematically illustrated transfer systems 12, which are used for gating in and/or gating out or branching the object to be conveyed 2. The design of the transfer system 12 and the way it operates will be described in detail with reference to the following drawings. This transport system 1 has a conveyor plane 14 formed by conveyor rollers 13, on which the object to be conveyed 2 or piece good is fed along the conveyor tracks 3, 4, 5 until a pre-definable inward and/or outward transfer operation or branching operation has to be performed by the transfer system 12.

In this respect, it should be pointed out that the transport system 1 illustrated and described here was chosen as just one of many different applications for the transfer system 12 and the transfer system 12 may be used with any other transport units or plants, in particular for conveying piece goods. This being the case, the transfer system 12 is able to convey in all directions relative to the conveying direction, for example perpendicular to, parallel with or at an angle to it.

FIGS. 2 to 13 illustrate different views of the transfer system 12 and its components in order to illustrate the operating principle and the way in which these components co-operate.

FIGS. 2 and 3, for example, are diagrams on an enlarged scale schematically illustrating a front view of the transfer system 12. The transfer system 12 has a base frame 15 in which a transfer device 16 is disposed. The transfer device 16 also has a lifting frame 17, a drive mechanism 18 retained on it, for example an electric motor or geared motor, as well as at least one conveyor means 19. The conveyor means 19 may be based on a variety of designs, including for example an endless belt, a chain, a belt transmission, rollers or similar. The transfer device 16 also has at least one lifting mechanism 20, by means of which the lifting frame 17 can be displaced relative to the base frame 15.

At its top face, the conveyor means 19 constitutes a transfer plane 21, and the lifting frame 17 and hence the transfer plane 21 formed by the conveyor means 19 can be reversibly displaced by means of the lifting mechanism 20 from a stand-by position disposed underneath the conveyor plane 14 of the transport system 1 into an operating position lying above the conveyor plane 14. As may also be seen from this embodiment illustrated as an example, the drive mechanism 18 is drivingly connected to both the conveyor means 19 and the lifting mechanism 20. This may be achieved directly or by means of interconnected countershafting or transmission systems.

The lifting mechanism 20 has a lifting rocker 22, which is mounted so that it can be reversibly displaced, in particular pivoted, on the base frame 15 about an axis 23 which is preferably oriented parallel with the transfer plane 21 from a non-operating position into a retaining position. With a view to retaining clarity, a detailed illustration of the bearing used to mount the lifting rocker 22 in the base frame 15 has been omitted and only parts of the base frame 15 are illustrated. The axis 23 may be a separate pivot shaft retained in the base frame 15, which constitutes a pivot point for the lifting rocker 22. However, any other type of bearing known from the prior art may be used for the lifting rocker 22. For example, the lifting rocker 22 could be provided with a circular bearing element, in particular may be connected to one, and this is in turn mounted on the base frame 15 in a known manner so that it is able to rotate or pivot. This again forms a radial bearing about a virtual pivot center point with an axis 23.

When the lifting rocker 22 is in the non-operating position, the lifting frame 17 together with the conveyor means 19 is disposed in the stand-by position underneath the conveyor plane 14. When the lifting rocker 22 is in the pivoted retaining position illustrated in FIG. 3, on the other hand, the lifting frame 17 together with the conveyor means 19 disposed on it is in the operating position in which the transfer plane 21 is disposed above the conveyor plane 14.

When the transfer device 16 is in the stand-by position, a conveying action can take place in the conveyor plane 14 on conveyor tracks 3 to 5 as far as the region of the transfer device 16. If the object to be conveyed 2 or piece good has to be gated in or gated out or transferred from one conveyor track 3 onto another conveyor track 4, 5, the lifting frame 17 and the conveyor means 19 connected to it are raised to the degree that the object to be conveyed 2 is lifted off the conveyor plane 14 of the conveyor track 3, after which the object to be conveyed 2 is then gated in and/or gated out or transferred by the conveyor means 19 onto the pre-definable conveyor track 4, 5 and after the transfer, the lifting frame 17 and the conveyor means 19 connected to it are returned to the stand-by position in which the transfer plane 21 is disposed underneath the conveyor plane 14.

The lifting mechanism 20 is used to effect the relative displacement of the lifting frame 17, in particular the lifting rocker 22, which has at least one rocker track 24 disposed in the direction perpendicular to the axis 23 but at a different distance 25 from it. The lifting mechanism 20 also has a drive element 26, but retained on the lifting frame 17, where it can be rotated about an axis of rotation 27 oriented parallel with the axis 23. The drive element 26 is likewise drivingly connected to the common drive mechanism 18. Accordingly, both the relative displacement of the lifting frame 17 with respect to the base frame 15 and the conveyor means 19 can be driven via a common drive mechanism 18. However, it would also be possible to dispose the drive mechanism 18 directly in the region of the axis of rotation 27 and drive the drive element 26 directly, optionally with an interconnected transmission or countershafting.

In this embodiment illustrated as an example, the drive element 26 is drivingly connected to the rocker track 24 of the lifting rocker 22 from its non-operating position until shortly before or on reaching the retaining position, and the drive element 26 is out of or is moved out of the drive connection to the rocker track 24 on reaching the retaining position. It is possible to interrupt transmission of the driving torque from the drive element 26 to the rocker track 24 because the drive connection is disengaged in the retaining position.

Irrespective of the above, however, it would also be possible for the drive element 26 to remain engaged with the rocker track 24 when the lifting rocker 22 is in the retaining position but transmission of the driving torque between the drive element 26 and drive mechanism 18 is interrupted. This may again be achieved in a variety of ways known from the prior art using driving torque-interruption means. To this end, it would be possible to use clutches which can be switched as and when necessary, slip clutches, eddy current brakes, etc., by means of which the drive in the drive train of the driving torque to be transmitted is interrupted. Accordingly, although the drive element 26 of the drive mechanism 18 always remains in the drive connection to the rocker track 24 of the lifting rocker 22, once the retaining position is reached, the drive connection between the drive element 26 and drive mechanism 18 is interrupted until there has been a return to the non-operating position. This may be achieved using the components mentioned above, and the driving torque can also be interrupted in the region of the drive element 26 itself. Accordingly, even if opting for these different solutions, the lifting movement is terminated on reaching the retaining position and unobstructed onward movement of the conveyor means 19 is possible without effecting another lifting movement or relative displacement of the lifting frame 17 with respect to the base frame 15.

When the lifting rocker 22 is disposed in the retaining position pivoted with respect to the non-operating position—as may best be seen from FIG. 3—an engagement establishing a driving connection between the drive element 26 and rocker track 24 is terminated or prevented, as a result of which the drive mechanism 18 and the conveyor means 19 connected to it can be driven in the same drive direction until the object or objects to be conveyed 2 has or have completely left the conveyor means 19 and been transferred to another conveyor track 4, 5.

In order to return the transfer device 16 from the operating position to the stand-by position, the drive mechanism 18 is operated in a direction of rotation opposite the previous one. Accordingly, the drive element 26 together with the rocker track 24 in turn move into the driving connection in order to effect a return from the operating position into the stand-by position, and the lifting rocker 22 is moved back from the pivoted retaining position into its non-operating position. The different possible embodiments of the drive element 26, lifting rocker 22 and rocker track 24 will be explained with reference to the following drawings.

As may also be seen from the diagrams of FIGS. 2 and 3, the axis 23 for retaining or mounting the lifting rocker 22 is oriented in a direction perpendicular to a conveying direction of the conveyor means 19. The rocker track 24 of the lifting rocker 22 is approximately V-shaped as viewed in the direction of the axis 23, and the rocker track 24 is disposed on the lifting rocker 22 on a portion directed towards the axis 23. This rocker track 24 may in turn be made up of several components, as will be explained in more detail below.

FIG. 2 illustrates the non-operating position of the lifting rocker 22 and, as may be seen, the distance 25 of the rocker track 24 from the axis 23 of the lifting rocker 22 is at its maximum in a vertical plane 28 extending through the axis 23. Due to the V-shaped design of the rocker track 22 mentioned above, the entire lifting frame 17 together with the conveyor means 19 can be held in position in its lowered position with respect to the conveyor plane 14—the stand-by position described above—without much in the way of additional requirements. When the lifting frame 17 is in the stand-by position, the lifting rocker 22 is oriented in its non-operating position.

Also illustrated in FIG. 4 by broken lines, starting from the maximum distance 25 in the region of the non-operating position, is an arc, the center point of which is disposed at the center of the axis 23. A radius of this arc is shown by reference 29. If the rocker track 24 were designed in the shape of this arc, displacing the lifting rocker 22 would not result in the relative position between the base frame 15 and lifting frame 17.

The longitudinal extension of the rocker track 24 starting from the plane 28 may be variously selected and, always starting from the non-operating position of the lifting rocker 22, the distance 25 of the rocker track 24 from the axis 23 of the lifting rocker 22 becomes shorter or smaller than the maximum distance 25 described above, the greater the distance 30 from the plane 28 extending vertically through the axis 23 extending plane 28. It is therefore possible to influence the displacement speed of the lifting frame 17 relative to the base frame 15 by choosing a different longitudinal extension for the rocker track 24. The decrease in the distance 25 of the rocker track 24 from the axis 23 determines the path which the transfer plane 21 must travel from the stand-by position through to the operating position.

In the embodiment illustrated as an example here, the rocker track 24 has part-portions 31, 32, which respectively extend in a straight line starting from their maximum distance 25 from the axis 23. When the lifting rocker 22 is in the non-operating position, the part-portions 31, 32 are preferably disposed symmetrically with respect to the plane 28. Disposed between the two part-portions 31, 32 of the rocker track 24 in the region of its maximum distance 25 from the axis 23 is a concave transition region 33 for connecting the two part-portions 31, 32. In order to enable the object to be conveyed 2 to be gated in or gated out in both conveying directions, it is of advantage if, when the lifting rocker 22 is in the non-operating position illustrated in FIG. 2, the rocker track 24 is disposed symmetrically with respect to the plane 28 extending vertically through the axis 23. As a result, the drive mechanism 18 can be driven in two directions of rotation and the desired conveying direction for the conveyor means 19 is initiated depending on the direction of rotation selected and in either case, the lifting frame 17 is moved relative to the base frame 15, usually in the vertical direction, by means of the lifting rocker 22, which is preferably of a symmetrical design.

It is also of advantage if, when the lifting rocker 22 is in the non-operating position and/or retaining position, the axis of rotation 27 of the drive element 26 is disposed underneath the axis 23 of the lifting rocker 22 in the vertical direction in each case. Due to the specific geometry of the lifting rocker 22, the drive element 26 moves so that it lies exactly underneath the axis 23 in the operating position and is supported on it free of gravity. As a result, no additional retaining force is needed for the lifting rocker 22.

FIGS. 4 to 6 provide a simplified illustration of one possible embodiment of the lifting rocker 22 and the drive element 26 drivingly connected to it in different positions in order to simplify the description of how the rocker track 24 and the lifting system for the lifting frame 17 connected to it operate.

The driving connection between the drive element 26 and lifting rocker 22, in particular the rocker track 24 disposed on it, is provided in the form of a meshing toothed connection, such as a gear 34 with a toothed rack 35. The toothed rack 35 forms a part-region or part-portion of the rocker track 24. FIG. 4 illustrates the non-operating position of the lifting rocker 22 relative to the plane 28, FIG. 5 illustrates an intermediate position during the pivoting movement of the lifting rocker 22 into the retaining position and FIG. 6 illustrates the retaining position of the lifting rocker 22. The maximum distance 25 between the rocker track 24 and the axis 23 and hence the stand-by position for the lifting frame 17 may be seen in FIG. 4. If the distance 25 is reduced, depending on the diameter of the gear 34 used, another distance 36 is formed between the axis 23 of the lifting rocker 22 and the axis of rotation 27 of the drive element 26. During the course of the rotating movement of the drive element 26 and the gear 34 which is now meshing with the toothed rack 35, the lifting frame 17 is lifted relative to the base frame 15 due to the fact that the lifting frame 17 is guided in the base frame 15—this may be achieved by means of a linear guide for example—as a result of the shortening of the distance 25 described above, so that a distance 37 between the axis of rotation 27 and the axis 23 becomes shorter than the distance 36 described above with reference to FIG. 4. A displacement path 38 of the lifting frame 17 relative to the base frame 15 is equal to the longer distance 36—FIG. 4—minus the shorter distance 37—FIG. 6.

Finally, FIG. 6 illustrates the minimum distance 37 between the axis 23 and the axis of rotation 27 and the maximum displacement path 38 of the lifting frame 17 relative to the base frame 15.

FIGS. 7 to 13 provide a detailed illustration of one possible embodiment of the lifting rocker 22 in co-operation with the drive element 26, in both the non-operating position and in the pivoted retaining position. As briefly explained above with reference to FIGS. 4 to 6, the driving connection between the drive element 26 and lifting rocker 22 is established by the mutually meshing toothed connection of the gear 34 and toothed rack 35. With a view to retaining clarity, some of the connecting elements and retaining elements between the components described individually below in conjunction with the lifting rocker 22 and drive element 26 have been omitted from the drawings. These may be freely selected from those known from the prior art.

On the side remote from the axis 23, the lifting rocker 22 may have a retaining frame of an approximately L-shaped design, by means of which the toothed rack 35 is connected, in particular with an interconnected spacer strip, although this is not illustrated. The driving connection between the drive element 26 and lifting rocker 22 provides the requisite torque for pivoting the lifting rocker 22 and lifting the lifting frame 17 at the same time.

In order to support the full weight of the lifting frame 17 with the units and devices disposed on it as well as the object to be conveyed 2 as it is being transferred, it is of advantage if, in order to adjust the backlash between the gear 34 and toothed rack 35, a support region 39 is additionally provided or disposed on the drive element 26 at its circumference, which is supported on a stabilizing surface 40 provided on the lifting rocker 22. This support region 39 may be provided on the drive element 26 in the form of a schematically illustrated stabilizing wheel 41, for example. The stabilizing surface 40 for the drive element 26 described above may be disposed in the region of the lifting rocker 22 in the form of a separate component, for example a stabilizing rail 42, which is a component part of the lifting rocker 22. In order to set an exact tooth engagement, the longitudinal extension of the stabilizing surface 40 of the stabilizing rail 42 is adapted to the longitudinal extension of the toothed rack 35. As a result, an exact backlash is set between the gear 34 and toothed rack 35, as a result of which the supporting force between the support region 39 and stabilizing surface 40 is transferred and the torque is transmitted in the region of the toothed connection.

As may be seen from a comparison of FIGS. 7 and 10 and as described above, the drive mechanism 18 is in a driving connection with the lifting rocker 22 via the drive element 26 from the non-operating position until shortly before reaching the retaining position and on reaching the retaining position, the driving connection between the drive mechanism 18 and the drive element 26 and lifting rocker 22 is released by releasing the toothed rack 35 for example. As before, the support region 39 continues to be supported on the stabilizing surface 40.

In order to position the lifting rocker 22 correctly relative to the stationary base frame 15 in its retaining position for the lifting frame 17, a stop region 43 is also provided between the drive element 26 and its circumference, which moves into contact with and is supported on a contact element 44 provided on the lifting rocker 22 once the lifting rocker 22 has reached the retaining position. As may be seen from a comparison of FIGS. 9 and 12, the stop region 43 of the drive element 26 on the lifting rocker 22 is disengaged or released starting from the non-operating position and is not supported on the contact element 44 until reaching or immediately after reaching the retaining position. If the lifting rocker 22 is of a symmetrical design, it is of advantage if a contact element 44 is provided at each of the mutually remote ends of the part-portions 31, 32 of the rocker track 24. Another option is for the contact elements 44 to be retained on a separate support rail 45 at its end regions in each case and these in turn constitute another component of the lifting rocker 22. To enable the lifting rocker 22 to be displaced or pivoted without collision, a longitudinal extension of the support rail 45 on the side directed towards the axis 23 approximately corresponds to that of the rocker track 24, which constitutes the toothed rack 35 in the case of the embodiment described as an example here. This being the case, a minimum spacing of the longitudinal extension of the support rail 44 with respect to the stabilizing surface 40 and the rocker track 24 can be left free.

The contact element 44 forms a stop surface 46 directed towards the stop region 43 of the drive element 26, which has a portion co-operating with the stop element 44 complementing the stop region 43. Due to the fact that the stop region 43 on the drive element 26 is of a circular design, the stop surface 46 corresponds to an arc segment. This results in a virtually full surface contact of the entire drive element 26, in particular its stop region 43, with the contact element 44.

Due to the fact that the driving connection between the drive element 26 and lifting rocker 44, in particular the rocker track 24, is disengaged in the retaining position, the drive element 26 is able to turn or rotate further in the position supported on the contact element 44. Consequently, as described above, it is possible to operate with a single drive mechanism 18, and in this instance the conveyor means 19 can continue to be driven in the same direction of rotation until the object to be conveyed has been completely gated in or out. In order to interrupt the driving connection, the toothed rack 35 with its teeth disposed on it is shorter in its longitudinal extension and terminates before the contact element 44. As a result, when the stop region 43 of the drive element 26 is co-operating with the contact element 44 of the lifting rocker 22, the gear 34 is or moves out of the driving connection with the toothed rack 35.

The drive element 26 in the embodiment described as an example here also has a main body 47, on which the gear 34 is preferably retained and optionally also the stabilizing wheel 41.

As may best be seen from FIG. 13, the gear 34, support region 39, in particular the stabilizing wheel 41, and the stop region 43 are disposed or arranged on the main body 47 immediately adjacent to one another in the direction of the axis of rotation 27. It would also be possible for the main body 47 of the drive element 26 to be connected to a drive shaft 48 so as to rotate in unison with it in a known manner, in which case the drive shaft 48 is in turn rotatably mounted in the lifting frame 17 and the drive shaft 48 is also drivingly connected to the common drive mechanism 18.

FIGS. 14 to 20 illustrate another possible and optionally independent embodiment of the driving connection between the lifting rocker 22 and drive element 26 forming the lifting mechanism 20, the same reference numbers and component names being used to denote parts that are the same as those described in connection with FIGS. 1 to 13 above. To avoid unnecessary repetition, reference may be made to the detailed description of FIGS. 1 to 13 above.

The support frame forming the lifting rocker 22 may correspond to that of the embodiment already described in detail above.

In the case of the embodiment illustrated as an example here, the driving connection between the drive element 26 and lifting rocker 22 is provided in the form of a friction connection, for example a friction wheel 49, with a friction wheel rail 50. Due to the fact that the driving connection is established on the basis of friction in this embodiment, the arrangement described above comprising the support region 39 on the drive element 26 and the stabilizing surface 40 on the lifting rocker 22 may optionally be dispensed with. The friction wheel 49 of the drive element 26 is supported on the lifting rocker 22, in particular the friction wheel rail 50 disposed on it, from the non-operating position until shortly before reaching the retaining position.

The drive element 26 of this embodiment also has a stop region 51 at its circumference, which is supported on the contact element 44 provided on the lifting rocker 22 once the lifting rocker 22 has reached the retaining position. In the embodiment illustrated as an example here, the stop region 51 of the drive element 26 is provided in the form of a separate stop wheel 52, which is connected to the drive shaft 48 so as to rotate in unison with it. To provide support for the stop region 51, in particular the stop wheel 52, a contact element 44 is provided respectively at each of the mutually remote ends of the part-portions 31, 32 of the rocker track 24. In this connection, the contact elements 44 may be retained on the support rail 45 or may be of an integral design with it and again constitute another component of the lifting rocker 22. A longitudinal extension of the support rail 45 on the side directed towards the axis 23 also more or less corresponds to that of the rocker track 24. This ensures a simultaneous contact of the friction wheel 49 and stop region 51 with the friction wheel rail 50 and support rail 45. In terms of overall design, the support rail 45 and/or the friction wheel rail 50 are an integral part of the lifting rocker 22.

As may be seen from a comparison of FIGS. 15, 17 and 19, the lifting rocker 22 is in the position for retaining the lifting frame 17 and again, the drive element 26 is supported with its stop region 51 on the contact element 44 of the lifting rocker and the friction wheel 49 is disengaged from the friction wheel rail 50. This being the case, the drive element 26 is able to rotate freely relative to the lifting rocker 22 between the stop region 51 of the drive element 26 and the contact element 44 so that the lifting rocker 22 and the lifting frame 17 connected to it can in turn be retained in the operating position for the conveyor means 19.

The stop element or elements 44 again form a stop surface 46 directed towards the stop region 51, in particular the stop wheel 52 of the drive element 26, which is disposed in a portion co-operating with the drive element 26 complementing its stop region 51. In order to stop the driving connection between the friction wheel 49 and the friction wheel rail 50, the longitudinal extension of the friction wheel rail 50 terminates before the contact element 44 and the friction wheel rail 50 is released from the friction wheel 49. As a result, when the stop region 51 of the drive element 26 is co-operating with the stop element or elements 44 on the lifting rocker 22, the friction wheel 49 is disengaged from the driving connection with the friction wheel rail 50. The friction wheel 49 of the drive element 26 is connected to the drive shaft 48 so as to rotate in unison with it, and the drive shaft 48 is in turn rotatably mounted in the lifting frame 17 and the drive shaft 48 is also drivingly connected to the drive mechanism 18.

The contact between the stop region 43 and contact element 44, in particular its stop surface 46, is achieved due to the fact that a slide bearing effect is achieved during the rotation. This being the case, materials should be used which have a low coefficient of friction and/or are resistant to wear caused by friction.

FIG. 21 illustrates another possible and optionally independent embodiment of the drive element 26, the same reference numbers and component names being used for parts that are the same as those used for the description of FIGS. 1 to 20 above. Again, to avoid unnecessary repetition, reference may be made to the detailed description given above in connection with FIGS. 1 to 20.

By contrast with the diagram shown in FIG. 20, in order to form the stop region 51 with respect to the friction wheel 49 or drive shaft 48, the stop wheel 52 in this instance is mounted on the latter so as to rotate. The drive element 26 can be held in its retaining position on the contact element 44 in an even more efficient wear-free arrangement. Alternatively, however, it would also be possible to dispose a free-wheel device between the stop wheel 52 and drive shaft 48, although this is not illustrated here.

FIG. 22 illustrates a lifting rocker 22 similar to the design described in connection with FIGS. 14 to 19 above, the same reference numbers and component names being used to denote parts that are the same as those described in connection with FIGS. 1 to 21 above. Likewise, to avoid unnecessary repetition, reference may be made to the detailed description given in connection with FIGS. 1 to 21 above.

By contrast with the retaining position of the lifting rocker 22 relative to the base frame 15 illustrated in FIG. 15, the rocker track 24 is oriented with respect to a horizontally extending plane 53, starting from the drive element 26, by an angle 54 which rises with respect to it. This angle 54 with respect to the horizontal plane 53 is between 0.5° und 7°, preferably between 1° and 3°, in particular 2°. As a result, in keeping with the principle of inclined planes, the lifting rocker 22 is retained in a stable position in its retaining position relative to the base frame 15.

FIG. 23 provides a simplified, schematic illustration of an additional guide of the drive element 26 on a part-region of the lifting rocker 22 of the lifting mechanism 20. Again, the same reference numbers and component names are used to denote parts that are the same as those described in connection with FIGS. 1 to 22 above. To avoid unnecessary repetition, reference may be made to the detailed description of FIGS. 1 to 22 above.

As described in detail above in connection with FIGS. 14 to 20, a component of the lifting rocker 22, namely the support rail 45, forms a support track 55 extending more or less parallel with the rocker track 24 on the lifting rocker 22 on the side facing away from the axis 23. The drive element 26 of the lifting rocker 22 is provided with at least one pressing element 56 in this instance, which is supported on the support track 55 during the entire pivoting movement of the lifting rocker 22 on it. This results in an even more efficient guiding action and contact of the drive element 26, including for the purpose of transmitting torque to the rocker track 24. As a result, force can be transmitted in a controlled manner from the drive element 26 through to the rocker track 24. The pressing element 56 may be provided in the form of at least one, but preferably two or more pressing rollers 57.

FIG. 24 illustrates another possible and optionally independent embodiment for supporting and positioning the lifting rocker 22 in its retaining position, the same reference numbers and component names being used to denote parts that are the same as those described in connection with FIGS. 1 to 23 above. To avoid unnecessary repetition, reference may be made to the detailed description of FIGS. 1 to 23 above.

In the case of the embodiment illustrated as an example here, the driving connection between the drive element 26 and lifting rocker 22 is provided by means of a meshing action based on friction, as described in detail above in connection with FIGS. 14 to 23. Disposed in the region of the drive element 26 is a driving wheel 58, in particular a friction wheel 49, and before or when the lifting rocker reaches the retaining position 22, the driving wheel 58 is disconnected from the driving connection with the rocker track 24 formed by the friction wheel rail 50. In this retaining position, the driving wheel 58 is provided with a first and a second stabilizing wheel 59, 60 as contact elements 44 on the lifting rocker 22. During the displacement from the non-operating position, the driving wheel 58, in particular the friction wheel 49, is drivingly connected to the friction wheel rail 50, and shortly before the lifting rocker 22 reaches or as it reaches the pivoted retaining position, the drive element 26 moves into contact with the two stabilizing wheels 59, 60 and hence in abutment. Due to the two stabilizing wheels and the disengagement of the driving wheel 58 from the rocker track 24, in particular the friction wheel rail 50, the drive element 26 can be freely rotated by the drive mechanism 18 without the lifting rocker 22 shifting at the same time.

The first stabilizing wheel 59 is mounted on the lifting rocker 22 so that it can rotate more or less in the remaining longitudinal extension of the rocker track 24 and spaced at a distance apart from it. The other stabilizing wheel 60 is mounted on the lifting rocker 22 in an end region of the rocker track 24 so that it can rotate and is disposed so that when the driving wheel 58 engages with the second stabilizing wheel 60 it is disengaged from the driving connection with the rocker track 24, in particular the friction wheel rail 50. It is also of advantage if the other stabilizing wheel 60 is provided with a free-wheel device, although this is not illustrated, so that on reaching the retaining position, an unhindered continuing rotation can take place in the same driving direction of the drive element 26. If the direction of rotation of the drive mechanism 18 and hence the drive element 26 is changed, the driving wheel 58 is in turn moved back towards the friction wheel rail 50 by means of the stabilizing wheel 60, which is now blocked by the free-wheel device, and the lifting rocker 22 is returned to the non-operating position in a controlled manner.

Instead of the displacement direction of the lifting frame 17 relative to the base frame 15 extending vertically with respect to the transfer plane 21 as illustrated in FIGS. 2 and 3, it would also be possible to opt for any other relative guiding action of the lifting frame 17 with respect to the base frame 15. One of these possibilities is schematically indicated in FIG. 25, and is so on the basis of a toggle joint in the base frame 15 arranged so that it can be connected to the lifting frame 17. In this embodiment, in addition to the vertical displacement, there is also a slight transverse displacement with respect to the vertical. However, this is of secondary importance in the case of such systems and in terms of the short lifting height needed between the stand-by position and operating position. This lifting height is between I mm and 50 mm, for example, in a manner known per se.

The embodiments illustrated as examples represent possible variants of the transfer system, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the structure of the transfer system 12, in particular its lifting mechanism 20, it and its constituent parts are illustrated to a certain extent out of scale and/or on an enlarged scale and/or on a reduced scale.

The objective underlying the independent inventive solutions may be found in the description.

Above all, the individual embodiments of the subject matter illustrated in FIGS. 1; 2 to 13; 14 to 20; 21; 22; 23; 24; 25 constitute independent solutions proposed by the invention in their own right. The objectives and associated solutions proposed by the invention may be found in the detailed descriptions of these drawings.

### List of Reference Numbers

1 Transport system

2 Object to be conveyed

3 Conveyor track

4 Conveyor track

5 Conveyor track

6 Control system

7 Control device

8 Data bus

9 Data network

10 Material flow computer

11 Host computer

12 Transfer system

13 Conveyor roller

14 Conveyor plane

15 Base frame

16 Transfer device

17 Lifting frame

18 Drive mechanism

19 Conveyor means

20 Lifting mechanism

21 Transfer plane

22 Lifting rocker

23 Pivot axis

24 Rocker track

25 Distance

26 Drive element

27 Axis of rotation

28 Plane

29 Radius

30 Distance

31 Part-portion

32 Part-portion

33 Transition region

34 Gear

35 Toothed rack

36 Distance

37 Distance

38 Displacement path

39 Support region

40 Stabilizing surface

41 Stabilizing wheel

42 Stabilizing rail

43 Stop region

44 Contact element

45 Support rail

46 Stop surface

47 Main body

48 Drive shaft

49 Friction wheel

50 Friction wheel rail

51 Stop region

52 Stop wheel

53 Plane

54 Angle

55 Support track

56 Pressing element

57 Pressing roller

58 Driving wheel

59 Stabilizing wheel

60 Stabilizing wheel

1. Transfer system for at least one conveyor track (3, 4, 5) having a transport system (1), in particular for gating in and/or gating out objects (2) to be conveyed, with a base frame (15), with a transfer device (16) comprising a lifting frame (17), a drive mechanism (18) and at least one conveyor means (19) which forms a transfer plane (21), and at least one lifting mechanism (20) by means of which the lifting frame (17) and hence the transfer plane (21) formed by the conveyor means (19) can be reversibly moved from a stand-by position disposed underneath a conveyor plane (14) of the transport system (1) into an operating position lying above the conveyor plane (14), and the drive mechanism (18) is drivingly connected to both the conveyor means (19) and the lifting mechanism (20), wherein the lifting mechanism (20) comprises a lifting rocker (22) which is mounted on the base frame (15) so that it can be reversibly displaced relative to an axis (23) from a non-operating position into a retaining position, and when the lifting rocker (22) is in the non-operating position, the lifting frame (17) is disposed with the conveyor means (19) in the stand-by position and when the lifting rocker (22) is in the retaining position, the lifting frame (17) with the conveyor means (19) is disposed in the operating position, and the lifting rocker (22) has at least one rocker track (24) which is disposed at a different distance (25) from it in the direction perpendicular to the axis (23), and a drive element (26) of the drive mechanism (18) is drivingly connected to the rocker track (24) of the lifting rocker (22) from its non-operating position until reaching the retaining position, and on reaching the retaining position, the drive element (26) is disconnected from the driving connection to the rocker track (24) or the drive element (26) of the drive mechanism (18) is always drivingly connected to the rocker track (24) of the lifting rocker (22) and the drive connection between the drive element (26) and the drive mechanism (18) is interrupted on reaching the retaining position.

2. Transfer system (12) according to claim 1, wherein the lifting mechanism (20) further comprises a drive element (26) which is retained on the lifting frame (17) and is rotatable about an axis of rotation (27) oriented parallel with the axis (23), and the drive element (26) is drivingly connected to the common drive mechanism (18).

3. Transfer system (12) according to claim 1, wherein the axis (23) of the lifting rocker (22) is oriented in a direction perpendicular to a conveying direction of the conveyor means (19).

4. Transfer system (12) according to claim 1, wherein the rocker track (24) of the lifting rocker (22) is V-shaped as viewed in the direction of its axis (23).

5. Transfer system (12) according to claim 1, wherein the rocker track (24) of the lifting rocker (22) is disposed on a portion directed towards the axis (23).

6. Transfer system (12) according to claim 1, wherein when the lifting rocker (22) is in the non-operating position, the distance (25) of the rocker track (24) from the axis (23) of the lifting rocker (22) is at a maximum in a plane (28) extending vertically through the axis (23).

7. Transfer system (12) according to claim 1, wherein when the lifting rocker (22) is in the non-operating position, the distance (25) of the rocker track (24) from the axis (23) of the lifting rocker (22) becomes shorter than the maximum distance (25) as the distance (30) from the plane (28) extending vertically through the axis (23) increases.

8. Transfer system (12) according to claim 1, wherein the rocker track (24) has part-portions (31, 32) which respectively extend in a straight line starting from their maximum (25) distance from the axis (23).

9. Transfer system (12) according to claim 8, wherein a concave transition region (33) is disposed between the part-portions (31, 32) of the rocker track (24) in the region of its maximum distance (25) from the axis (23).

10. Transfer system (12) according to claim 1, wherein when the lifting rocker (22) is in the non-operating position, the rocker track (24) is disposed symmetrically with respect to the plane (28) extending vertically through the axis (23).

11. Transfer system (12) according to claim 1, wherein when the lifting rocker (22) is in the non-operating position, the axis of rotation (27) of the drive element (26) is disposed underneath the axis (23) of the lifting rocker (22) in the vertical direction.

12. Transfer system (12) according to claim 1, wherein when the lifting rocker (22) is in the retaining position, the axis of rotation (27) of the drive element (26) is disposed underneath the axis (23) of the lifting rocker (22) in the vertical direction.

13. Transfer system (12) according to claim 1, wherein when the lifting rocker is in the retaining position, the rocker track (24) is oriented at an angle (54) with respect to a horizontally extending plane (53), rising with respect to it starting from the drive element (26).

14. Transfer system (12) according to claim 13, wherein the angle (54) is between 0.5° and 7°, preferably between 1° and 3°, in particular is 2°.

15. Transfer system (12) according to claim 1, wherein the drive connection between the drive element (26) and the lifting rocker (22) is provided in the form of a mutually engaging toothed connection, such as a gear (34) with a toothed rack (35).

16. Transfer system (12) according to claim 15, wherein the toothed rack (35) constitutes a part-region of the rocker track (24).

17. Transfer system (12) according to claim 1, wherein the drive element (26) also has a support region (39) on its circumference, which is supported on a support surface (40) on the lifting rocker (22).

18. Transfer system (12) according to claim 17, wherein the support region (39) on the drive element (26) is provided in the form of a stabilizing wheel (41).

19. Transfer system (12) according to claim 17, wherein the stabilizing surface (40) is disposed on a stabilizing rail (42) forming part of the lifting rocker (22).

20. Transfer system (12) according to claim 17, wherein the stabilizing surface (40) of the stabilizing rail (42) is adapted in terms of its longitudinal extension to a longitudinal extension of the toothed rack (35).

21. Transfer system (12) according to claim 1, wherein the drive element (26) also has a contact region (43) on its circumference which is supported on a contact element (44) disposed on the lifting rocker (22) when the lifting rocker (22) reaches the retaining position.

22. Transfer system (12) according to claim 21, wherein a stop element (44) is disposed respectively on mutually remote ends of the part-portions (31, 32) of the rocker track (24).

23. Transfer system (12) according to claim 21, wherein the stop elements (44) are retained on a support rail (45) and form another part of the lifting rocker (22).

24. Transfer system (12) according to claim 23, wherein a longitudinal extension of the support rail (45) on the side directed towards the axis (23) approximately corresponds to that of the rocker track (24).

25. Transfer system (12) according to claim 1, wherein the stop element (44) is disposed on a stop surface (46) directed towards the stop region (43) of the drive element (26), which is disposed in a portion co-operating with the drive element (26) complementing its stop region (43).

26. Transfer system (12) according to claim 1, wherein the toothed rack (35) terminates before the stop element (44) in its longitudinal extension.

27. Transfer system (12) according to claim 1, wherein when the stop region (43) of the drive element (26) is co-operating with the stop element (44) of the lifting rocker (22), the gear (34) is disengaged from the drive connection to the toothed rack (35).

28. Transfer system (12) according to claim 1, wherein the drive element (26) also has a main body (47).

29. Transfer system (12) according to claim 1, wherein the gear (34) and the stabilizing wheel (41) are retained on the main body (47).

30. Transfer system (12) according to claim 1, wherein the gear (34), support region (39) and stop region (43) are disposed immediately adjacent to one another in the direction of the axis of rotation (27).

31. Transfer system (12) according to claim 1, wherein the main body (47) of the drive element (26) is connected so as to rotate in unison with a drive shaft (48) and the drive shaft (48) is rotatably mounted in the lifting frame (17), and the drive shaft (48) is in a driving connection with the drive mechanism (18).

32. Transfer system (12) according to claim 1, wherein the drive connection between the drive element (26) and the lifting rocker (22) is provided in the form of a friction connection, such as a friction wheel (49) with a friction wheel rail (50).

33. Transfer system (12) according to claim 32, wherein the drive element (26) also has a stop region (51) on its circumference, which is supported on a stop element (44) disposed on the lifting rocker (22), when the lifting rocker (22) reaches the retaining position.

34. Transfer system (12) according to claim 32, wherein the stop region (51) of the drive element (26) is provided in the form of a stop wheel (52).

35. Transfer system (12) according to claim 34, wherein the stop wheel (52) is mounted on a drive shaft (48) so that it is rotatable relative to the friction wheel (49).

36. Transfer system (12) according to claim 32, wherein a freewheel device is disposed between the stop wheel (52) and the drive shaft (48).

37. Transfer system (12) according to claim 32, wherein the stop wheel (52) is connected to the drive shaft (48) so as to rotate in unison with it.

38. Transfer system (12) according to claim 32, wherein a stop element (44) is disposed respectively on mutually remote ends of the part-portions (31, 32) of the rocker track (24).

39. Transfer system (12) according to claim 32, wherein the stop elements (44) are retained on a support rail (45) and form another part of the lifting rocker (22).

40. Transfer system (12) according to claim 39, wherein a longitudinal extension of the support rail (45) on the side directed towards the axis (23) approximately corresponds to that of the rocker track (24).

41. Transfer system (12) according to claim 32, wherein the stop element (44) forms a stop surface (46) directed towards the stop region (51) of the drive element (26) which, in a portion co-operating with the drive element (26), complements its stop region (51).

42. Transfer system (12) according to claim 32, wherein the friction wheel rail (50) terminates before the stop element (44) in its longitudinal extension.

43. Transfer system (12) according to claim 32, wherein when the stop region (51) of the drive element (26) is co-operating with the stop element (44) of the lifting rocker (22), the friction wheel is disconnected from the drive connection to the friction wheel rail (50).

44. Transfer system (12) according to claim 32, wherein the friction wheel (49) of the drive element (26) is connected to the drive shaft (48) so as to rotate in unison with it, and the drive shaft (48) is mounted so as to be rotatable in the lifting frame (17) and the drive shaft (48) is drivingly connected to the drive mechanism (18).

45. Transfer system (12) according to claim 32, wherein a support track (55) is provided on the lifting rocker (22) on the side of the rocker track (24) remote from the axis (23) and extending approximately parallel with the rocker track (24), and at least one pressing element (56) supported on the support track (55) co-operates with the drive element (26) of the lifting rocker (22).

46. Transfer system (12) according to claim 45, wherein the pressing element (56) is provided in the form of at least one pressing roller (57).

47. Transfer system (12) according to claim 32, wherein the drive element (26) comprises a driving wheel (58), in particular a friction wheel (49), and when the lifting rocker (22) has reached the retaining position, the driving wheel (58) is disconnected from the drive connection to the rocker track (24) formed by the friction wheel rail (50), and a first and a second stabilizing wheel (59, 60) co-operates with the driving wheel (58) in this retaining position, acting as stop elements (44) on the lifting rocker (22).

48. Transfer system (12) according to claim 47, wherein the first stabilizing wheel (59) is disposed at a distance apart from the rocker track (24) in the rest of its longitudinal extension and is rotatably mounted on the lifting rocker (22).

49. Transfer system (12) according to claim 47, wherein the other stabilizing wheel (60) is rotatably mounted on the lifting rocker (22) in an end region of the rocker track (24) and is disposed so that the driving wheel (58) is disengaged from the drive connection to the rocker track (24), in particular to the friction wheel rail (50), when it engages with the second stabilizing wheel (60).

50. Transfer system (12) according to claim 47, wherein a freewheel device co-operates with the other stabilizing wheel (60).

51. Transfer system (12) according to claim 1, wherein when the stop region (43) of the drive element (26) is co-operating with the stop element (44), the lifting rocker (22) is retained in the retaining position and the conveyor means (19) is also driven in the same direction of rotation by the common drive mechanism (18).

52. Transfer system (12) according to claim 1, wherein the lifting frame (17) can be displaceably guided relative to the base frame (15) at least in a direction oriented approximately perpendicular to the transfer plane (21).
